(19) United States
(12) Patent Application Publication
(10) Pub. No.: US 2018/0303088 A1
(43) Pub. Date: Oct. 25, 2018

(54) application method to apply fungicides, pesticides, and other biocides to tree wounds by a dry process to prevent tree wound diseases and facilitate healing.

(71) Applicant: Arthur Robert Martin, JR., Shrewsbury, MA (US)

(72) Inventor: Arthur Robert Martin, JR., Shrewsbury, MA (US)

(21) Appl. No.: 15/494,581

(22) Filed: Apr. 24, 2017

(51) Int. Cl. A01N 25/12; C09D 5/14; A01N 43/90; A01N 59/20; A01N 59/14; A01N 65/00; B05D 1/28

(52) U.S. Cl. CPC A01N 25/12; C09D 5/14; A01N 43/90; A01N 65/20; A01N 59/14; A01N 65/00; B05D 1/28; A01N 59/20

(57) ABSTRACT

The invention is an application method that applies fungicides, pesticides and other biocides to tree wounds by means of a dry process to prevent tree wound diseases and facilitate healing. The invention works with the first step of tree's natural healing process; the drying of the exposed wood surface. The biocides are applied dry or in a liquid formulation that dries quickly thus allowing the wood to dry quickly. The biocides, thus applied, do not interfere with the natural drying process and add additional biocidal protection. The biocides, thus applied, decrease infection and enhance the tree's ability to heal itself.

### STATEMENT REGARDING FEDERALLY SPONSORED RESEARCH OR DEVELOPMENT

This invention was not sponsored by the Federal Government (USA) or any other agency.

### CROSS-REFERENCE TO RELATED APPLICATIONS

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The invention pertains to the field of arboriculture.

In 2004, I . . . (the inventor) . . . purchased a small farm in central New York. The farm had a 10 acre apple orchard within its boundaries with trees approaching 100 years of age. The diameters of the oldest trees were impressive, three feet in some cases, but upon close inspection many of the ancient trees were hollow inside; the heartwood having rotted away. The trees were still standing, supported by a shell of the living cambium wood, and they were still productive, producing a crop of apples every year, but it was clear the trees were dying. In late summer large branches would break off, weighted down by the annual apple load; the rot in the heartwood having spread to the branch.

The orchard also had younger trees, perhaps 20 years of age, and when I walked through the orchard in the winter months, after the annual prune, I noticed that the vast majority of pruned branches were 1^{st} and 2^{nd} year branches (<1 inch in diameter) but occasionally I'd find an older, larger diameter branch that had been removed because of disease or damage. As I walked along further, I could see that these larger wounds were often the gateway for disease to enter the heartwood.

If a fungal agent had not breached the wood exposed by the cut, the tree would have healed itself naturally by growing a callus of living wood over the wound thus protecting the heart wood from infection. The ancient trees on the property would still have intact heart wood and they would still have the potential to produce large crops of apples for many more years.

When I was a child, my father treated tree wounds with a black tar-like paint that he purchased commercially. He treated a large dogwood tree in this way, a favorite climbing tree of mine and, in the following year, on one of my childhood climbs, I noticed the black paint was loose so I peeled it back, like a scab, and observed moisture trapped inside. I could also see the beginning of rot. The black paint had not helped the wound heal but had made it worse.

Arborists have since confirmed my childhood observation and they recommend that branches be cut off cleanly and the wound allowed to heal naturally¹⁾.

In the natural healing process, the first step is the drying of the surface of the wood exposed by the cut. If it dries well, the surface forms a grey cellulose/lignin barrier to infection. Then, in time, the tree grows a callus of living wood over the dry wood, thus sealing it, and protecting the heart wood from infection. The drying of the surface of the damaged wood is a critical step in the natural healing process. Applying a paint to the surface, even a paint with fungicidal properties, traps moisture that works against the natural healing process.

Evidence supporting the importance of the dry wood step comes, oddly enough, from the kitchen. Sanitary studies on the merits of wood cutting boards versus plastic cutting boards have shown that wood surfaces inhibit microbial growth²⁾.

Paints, like the paint my father used many years ago, are still on the market with no other alternative.

As a scientist, I began experimenting with better topical treatments.

### REFERENCES CITED

1) https://wwww.purdue.edu/hia/sites/yardandgarden/extpub/pruning-ornamental-trees-and-shrubs/
2) Ak, N. O., D. O. Cliver, and C. W. Kaspar. 1994. Cutting boards of plastic and wood contaminated experimentally with bacteria. J. Food Protect. 57: 16-22.

### BRIEF SUMMARY OF THE INVENTION

The invention is a dry application process that works with the first step of tree's natural healing process. The biocides are applied dry, or in a liquid formulation that dries quickly, thus allowing the exposed wood to dry quickly. The biocides, thus applied, do not interfere with the natural drying process and add additional biocidal protection. The biocides, thus applied, decrease infection and enhance the tree's ability to heal itself.

The application method lengthens the productive life of a tree, in the case of the apple tree, by decades.

Unlike products that are currently on the market, it is not a paint, fatty acid, gum or resin with hydrophobic properties that trap moisture against the wound.

### BRIEF DESCRIPTION OF THE SEVERAL VIEWS OF THE DRAWING

FIG. 1 Mode of Action

Magnified depiction of the treatment permeating the surface of the exposed wood of a pruned branch.

FIG. 2 Apple Tree with Pruned Branches.

The branches on this tree were cleanly cut.

FIG. 3 Apple Tree with Chemical Treatment

The copper sulfate in the chemical treatment colors the wood blue (the color eventually fades away).

FIG. 4 Apple Tree with Callused Wounds In-Process of Healing and Healed)

The healing wound was the first wound treated experimentally.

### DETAILED DESCRIPTION OF THE INVENTION

The invention applies fungicides, pesticides and other biocides to tree wounds by a dry process.

### Example 1

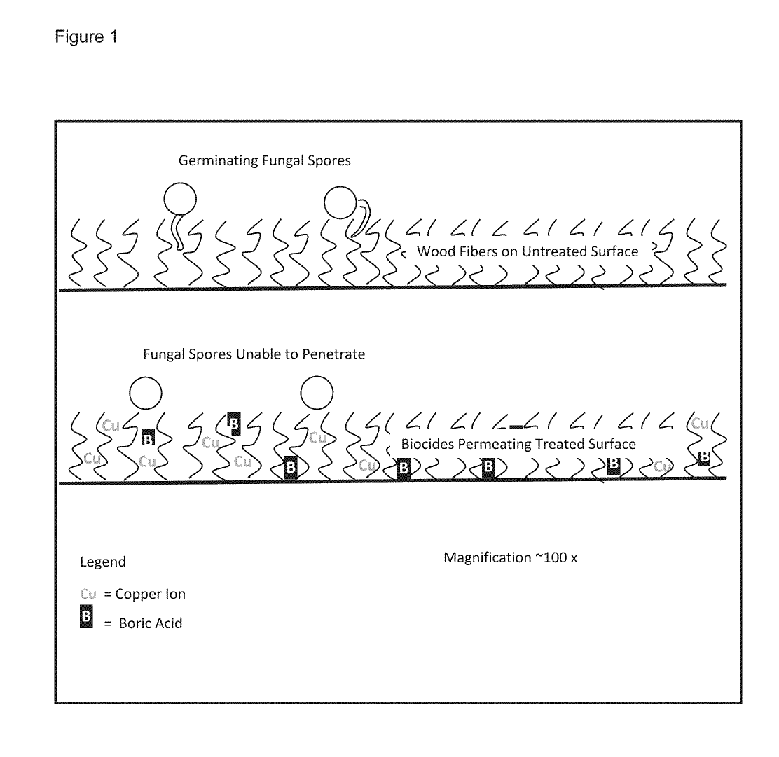

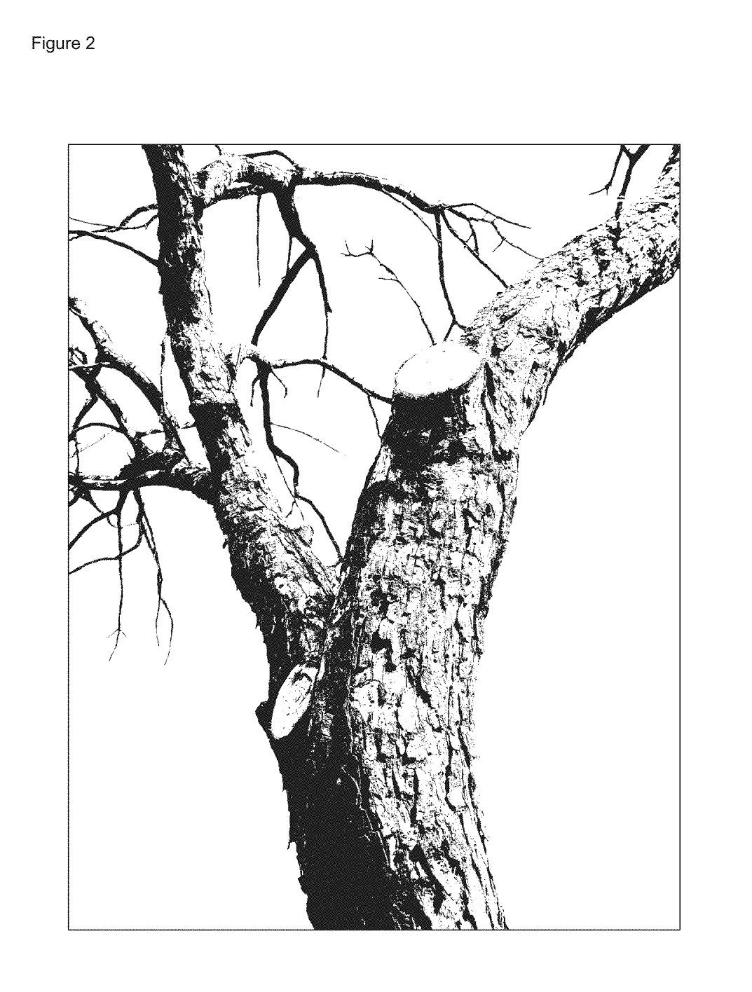

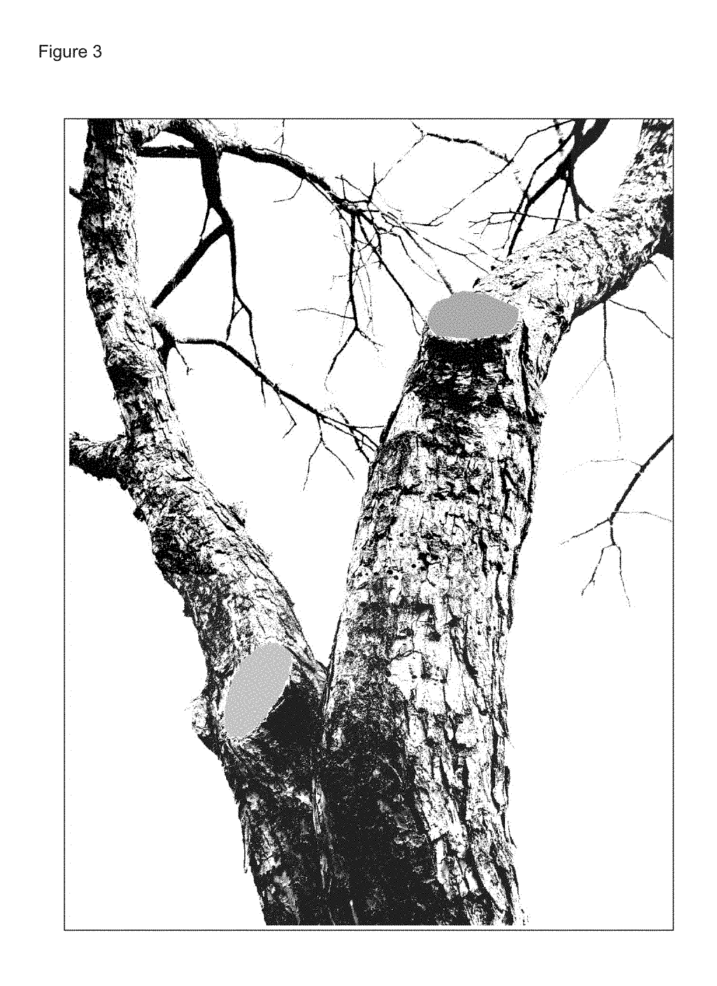

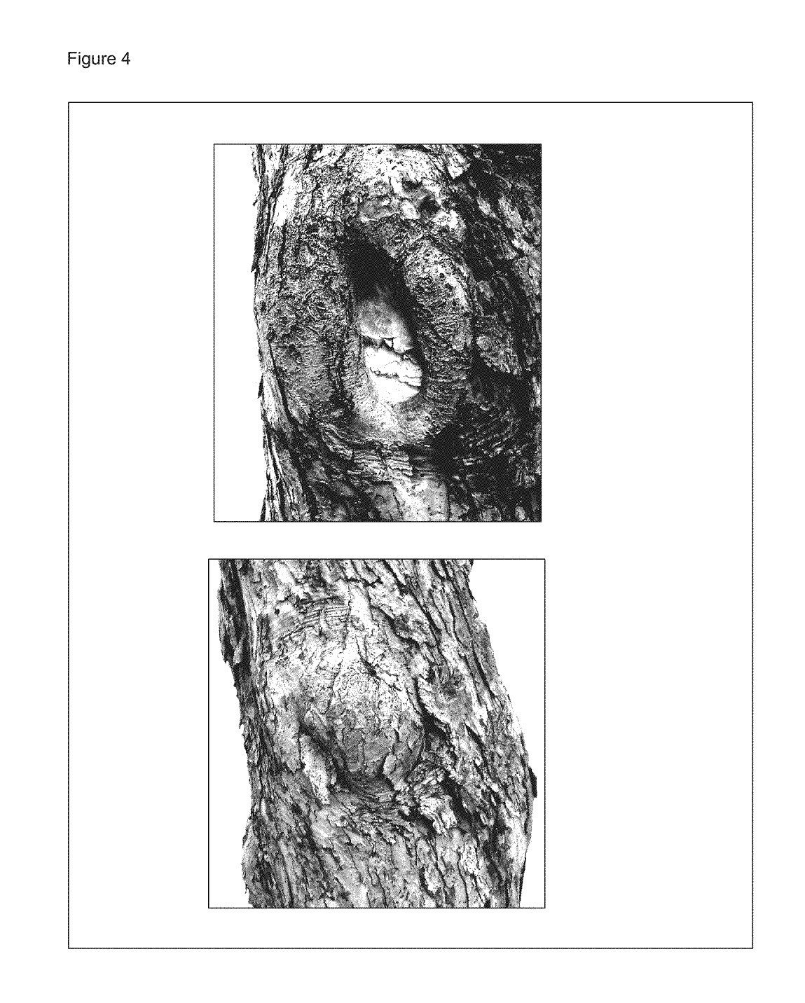

A powdered formulation is dry brushed onto the tree wound. FIG. 1 is a magnified depiction of the applied chemicals permeating the wood surface. FIGS. 2 and 3 show the application process using copper sulfate and rotenone. FIG. 4 shows the healing process.

### Example 2

The biocide(s) are dissolved or suspended in water and/or organic solvent and applied to the cut surface by aerosol spray. The diluent evaporates leaving the dry ingredients on the surface of the wound.

### Example 3

The biocide(s) are prepared as a dust and applied with dusting equipment,

Notes: Copper sulfate's fungicidal properties were first discovered by Professor A, Millardet in the late 1800s.³⁾ His discovery saved the European wine industry from a fungus that was ravaging vineyards at the time. Boric acid was first registered as an insecticide by the Environmental Protection Agency (EPA) in 1948⁴⁾, Rotenone, also an insecticide, is derived from plants in the legume family. In early history, it was used as a piscicide to harvest fish from lakes and streams⁵⁾.

### REFERENCES CITED

3) Annales de la Socie′te′d′ Agriculture de la Girande, April 1885, p 73
4) USEPA, Prevention, Pesticides and Toxic Substances (7508W), EPA-738-F-93-006, September 1993
5) Kevin C. Ott, Rotenone. A Brief Review of its Chemistry, Environmental Fate, and the Toxicity of Rotenone Formulations, www.newmexicotu.org/Rotanone %20summary.pdf

1. A method for applying fungicides, pesticides and other biocides to tree and bush wounds by a dry process comprising of: preparing a powdered biocide formulation; coating a brush; and brushing on the exposed wood surface.

2. The method in claim 1 wherein the formulation step is accomplished by dissolving and/or suspending the biocides in water, organic solvent, or water/organic solvent mix.

3. The method in claim 2 wherein the coating and brushing steps are accomplished by spray or aerosol.

4. The method in claim 1 wherein the formulation step is accomplished by making a dust.

5. The method in claim 4 wherein the coating and brushing steps are accomplished by dusting.
